(19) United States
(12) Patent Application Publication
(10) Pub. No.: US 2018/0192615 A1
(43) Pub. Date: Jul. 12, 2018

(54) ANIMAL PILL FEEDER

(71) Applicant: Larry Jones, San Angelo, TX (US)

(72) Inventor: Larry Jones, San Angelo, TX (US)

(21) Appl. No.: 15/404,803

(22) Filed: Jan. 12, 2017

(51) Int. Cl. A01K 13/00; A01K 29/00

(52) U.S. Cl. CPC A01K 13/003; A01K 29/00

(57) ABSTRACT

An animal pill feeder having a hollow tube having a first end and a second end, a bulb placed on the first end of the hollow tube, the bulb is adapted to push air through the hollow tube and a bladder placed on the second end of the hollow tube, the bladder contains a pill that is adapted to open and release the pill when the bladder receives the pushed air through the hollow tube after the animal pill feeder is inserted into an animal's or a pet's mouth and behind the animal's or the pet's tongue.

### BACKGROUND OF THE INVENTION

### Field of the Invention

The present invention is a feeder. More specifically, the present invention is an animal pill feeder.

### Descritpion of the Related Art

Many times, a pet or other animal requires a pill to be taken, often at a veterinarian's recommendation. The veterinarian often must position the pill behind the animal's tongue. It is a natural tendency for an animal or a pet to reject or spit-out an object such as a pill and many times a device or a feeder is required for administering the pill in such a way that the animal or the pet does not reject or spit-out the pill.

What is needed is an animal pill feeder that may safely and efficiently feed an animal or a pet a pill.

### SUMMARY OF THE INVENTION

The present invention is a feeder. More specifically, the present invention is an animal pill feeder.

The animal pill feeder includes having a hollow tube having a first end and a second end, a bulb placed on the first end of the hollow tube, the bulb is adapted to be squeezed to push air through the hollow tube and a bladder placed on the second end of the hollow tube, the bladder contains a pill that is adapted to open and release the pill when the bladder receives the pushed air through the hollow tube after the animal pill feeder is inserted into an animal's or a pet's mouth and behind the animal's or the pet's tongue.

It is an object of the present invention to provide an animal pill feeder that may safely and efficiently feed an animal or a pet a pill.

It is an object of the present invention to provide an animal pill feeder that gives a pill to an animal through a tube which is hollow with a bulb on one end which pushes air through a hollow tube and opens a bladder which holds the pill confined inside tube.

It is an object of the present invention to provide an animal pill feeder that is made from soft rubber so not to harm an animal's mouth and throat.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a side view of an animal pill feeder, in accordance with one embodiment of the present invention.

FIG. 2 illustrates an overhead view of an animal pill feeder, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. These operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

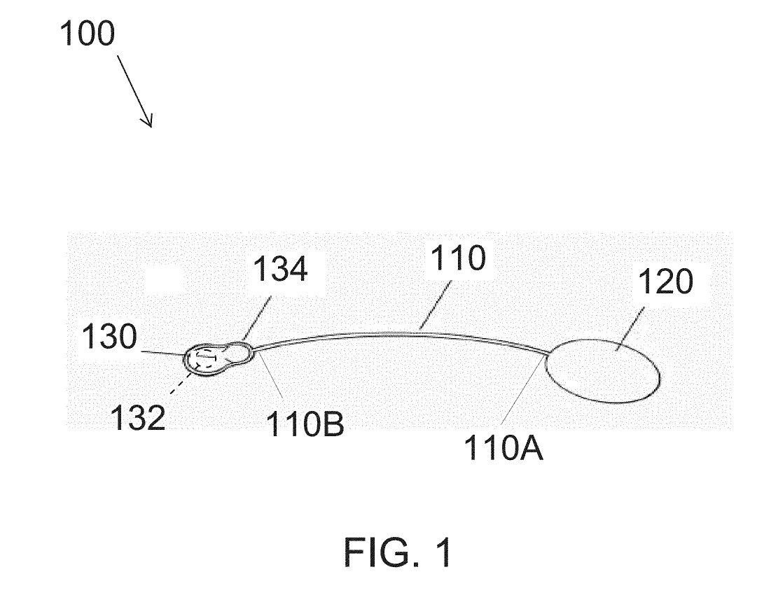

FIG. 1 illustrates a side view of an animal pill feeder 100, in accordance with one embodiment of the present invention.

The animal pill feeder 100 may include a hollow tube 110, a bulb 120 and a bladder 130.

The hollow tube 110 may have a first end 110A and a second end 110B. The bulb 120 may be placed on the first end 110A of the hollow tube 110 and is adapted to push air through the hollow tube 110. The bladder 130 may be placed on the second end 110B of the hollow tube 110 to contain a pill 132 that is adapted to open and release the pill 132 when the bladder 130 receives the pushed air through the hollow tube 110 after the animal pill feeder 100 is inserted into an animal's or a pet's mouth and behind the animal's or the pet's tongue. The bladder 130 may also include an outer support 134 that attaches the bladder 130 to the second end 110B of the hollow tube 110. The outer support 134 may be made of soft but firm rubber or other suitable material and is approximately ¾ ths of an inch wide.

The animal pill feeder 100 may be made from soft rubber, soft plastic or other material so not to harm the animals mouth and tongue and has no metal components. The animal pill feeder 100 may be approximately in the range of eight to ten inches long to properly release the pill from the bladder behind the animal's or pet's throat.

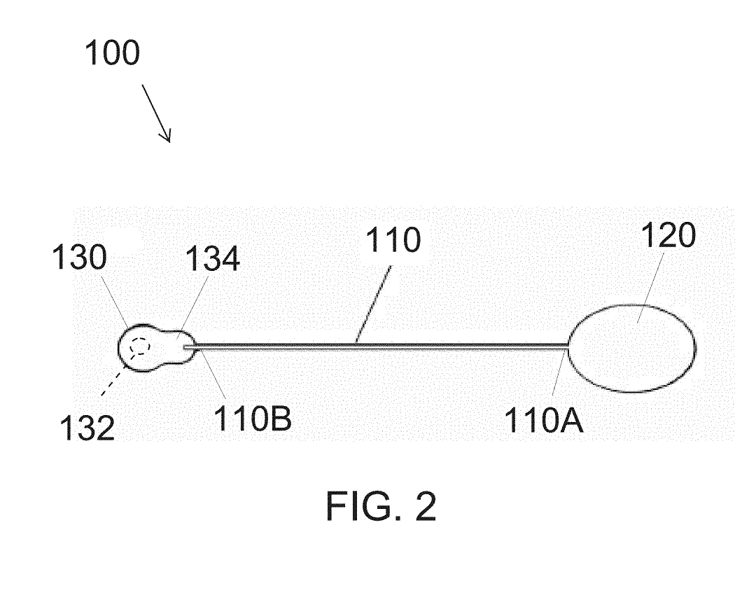

FIG. 2 illustrates an overhead view of an animal pill feeder 100, in accordance with one embodiment of the present invention.

The hollow tube 110 may be rubber coated and may be approximately ⅛^{th} of an inch in diameter or other suitable width. The rubber coating may be a relatively hard rubber coating or other similar rubber coating. The bladder 130 may be made of pliable rubber or other suitable material, which facilitates the bladder 130 that is adapted to open and release the pill 132 when the bladder 130 receives the pushed air through the hollow tube 110 after the animal pill feeder 100 is inserted into an animal's or a pet's mouth and behind the animal's or the pet's tongue.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. An animal pill feeder, comprising:
a hollow tube having a first end and a second end;
a bulb placed on the first end of the hollow tube, the bulb is adapted to push air through the hollow tube; and
a bladder placed on the second end of the hollow tube, the bladder contains a pill that is adapted to open and release the pill when the bladder receives the pushed air through the hollow tube after the animal pill feeder is inserted into an animal's or a pet's mouth and behind the animal's or the pet's tongue.

2. The animal pill feeder according to claim 1, wherein the animal pill feeder is made of soft rubber.

3. The animal pill feeder according to claim 1, wherein the animal pill feeder is made of soft plastic.

4. The animal pill feeder according to claim 1, wherein the animal pill feeder is in the range of eight to ten inches long to properly release the pill from the bladder behind the animal's or pet's throat.
